(19) United States
(12) Patent Application Publication
(10) Pub. No.: US 2016/0316264 A1
(43) Pub. Date: Oct. 27, 2016

(54) ELECTRONIC DEVICE, DISPLAY APPARATUS, AND METHOD OF OPERATING THE ELECTRONIC DEVICE

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Je-hwan SEO, Daegu (KR); Dae-sik KIM, Anyang-si (KR); Bong-won SUH, Seoul (KR); Joong-seek LEE, Seoul (KR)

(21) Appl. No.: 15/134,766

(22) Filed: Apr. 21, 2016

(30) Foreign Application Priority Data
Apr. 21, 2015 (KR) 10-2015-0056174

(51) Int. Cl. H04N 21/442; H04N 21/235; H04N 21/258; H04W 4/00; H04N 21/41

(52) U.S. Cl. CPC H04N 21/44218; H04W 4/008; H04N 21/4126; H04N 21/44204; H04N 21/25866; H04N 21/235

(57) ABSTRACT

An electronic device includes a communicator comprising communication circuitry, and a controller configured to control the communicator to receive a beacon signal including content information, to acquire location information based on the beacon signal, and to transmit a packet to a server, the packet including the content information, the location information, and use log information.

### CROSS-REFERENCE TO RELATED APPLICATION

This application is based on and claims priority under 35 U.S.C. §119 to Korean Patent Application No. 10-2015-0056174, filed on Apr. 21, 2015, in the Korean Intellectual Property Office, the disclosure of which is incorporated by reference herein in its entirety.

### BACKGROUND

1. Field

The present disclosure relates to an electronic device, a display apparatus, and a method of operating the electronic device, and for example, to an electronic device for efficiently surveying an audience rating, a display apparatus, and a method of operating the electronic device.

2. Description of Related Art

With advances in communication technologies and various media, the broadcasting communications industry has rapidly developed. An audience rating of content provided by a broadcaster is an important concern in the broadcasting communications industry. Therefore, there is a need for a content audience rating survey method that is capable of surveying a content audience rating accurately and efficiently.

### SUMMARY

An electronic device for efficiently surveying an audience rating, a display apparatus, and a method of operating the electronic device are provided.

Additional aspects will be set forth in part in the description which follows and, in part, will be apparent from the description.

According to an aspect of an example embodiment, an electronic device includes: a communicator comprising communication circuitry; and a controller configured to control the communicator to receive a beacon signal including content information, to acquire location information based on the beacon signal, and to transmit a packet to a server, the packet including the content information, the location information, and use log information.

The controller may be configured to acquire the location information based on a received signal strength indication (RSSI) of the beacon signal.

The controller may be configured to receive the beacon signal through a Bluetooth Low Energy (BLE) technology, e.g., the beacon signal may comprise a BLE signal.

The controller may be configured to receive the beacon signal from a display apparatus or a set-top box connected to the display apparatus.

The controller may be configured to receive a second beacon signal from at least one beacon and to acquire the location information based on the beacon signal and the second beacon signal.

According to an aspect of another example embodiment, a display apparatus includes: a communicator comprising communication circuitry; and a controller configured to control the communicator to receive a streaming signal, to receive a beacon signal from an electronic device, the beacon signal including user information and use log information, and to transmit a packet to a server, the packet including content information acquired by parsing the streaming signal, the user information, and the use log information.

The streaming signal may include a broadcasting signal or a signal provided by a video on demand (VOD) service.

The streaming signal may include a header and a payload, the header may include content information, and the payload may include at least one of a video signal and an audio signal for content output.

The streaming signal may include a transport stream packet.

The display apparatus may further include an output comprising output circuitry configured to output at least one of the video signal and the audio signal.

The controller may be configured to receive a content recommendation service from the server.

The controller may be configured to acquire location information of the electronic device based on a received signal strength indication (RSSI) of the beacon signal, and the packet further includes the location information of the electronic device.

The controller may be configured to receive the beacon signal through a Bluetooth Low Energy (BLE) technology e.g., the beacon signal may comprise a BLE signal.

According to an aspect of another example embodiment, a set-top box includes: a communicator comprising communication circuitry; and a controller configured to control the communicator to receive a streaming signal, to transmit a beacon signal including content information acquired by parsing the streaming signal, and to transmit one or more of a video signal and an audio signal based on the streaming signal to a display apparatus.

According to an aspect of another example embodiment, a method of operating an electronic device includes: receiving a beacon signal including content information; acquiring location information based on the beacon signal; and transmitting a packet to a server, the packet including the content information, the location information, and use log information.

The location information may be acquired based on a received signal strength indication (RSSI) of the beacon signal.

The beacon signal may be received through a Bluetooth Low Energy (BLE) technology, e.g., the beacon signal may comprise a BLE signal.

The beacon signal may be received from a display apparatus and a set-top box connected to the display apparatus.

The method may further include receiving a second beacon signal from at least one beacon, wherein the location information is acquired based on the beacon signal and the second beacon signal.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1 is a block diagram illustrating an example audience rating survey system;

FIG. 2 is a flow diagram illustrating an example audience rating survey method;

FIG. 3 is a diagram illustrating an example configuration of a streaming signal;

FIG. 4 is a diagram illustrating an installation example of a display apparatus and beacons;

FIG. 5 is a diagram illustrating example use log information of an electronic device;

FIG. 6 is a block diagram illustrating an example audience rating survey system;

FIGS. 7 to 11 are flow diagrams illustrating examples of audience rating survey methods;

FIG. 12 is a block diagram illustrating an example electronic device;

FIG. 13 is a block diagram illustrating an example display apparatus;

FIG. 14 is a block diagram illustrating an example set-top box;

FIG. 15 is a block diagram illustrating an example server;

FIG. 16 is a block diagram illustrating an example wearable device; and

FIG. 17 is a flowchart illustrating an example method of operating an electronic device.

### DETAILED DESCRIPTION

Reference will now be made in greater detail to example embodiments, examples of which are illustrated in the accompanying drawings, wherein like reference numerals refer to like elements throughout. In this regard, the present example embodiments may have different forms and should not be construed as being limited to the descriptions set forth herein. Accordingly, the example embodiments are described below, by merely referring to the figures, to explain aspects of the present disclosure. Expressions such as “at least one of” when preceding a list of elements, modify the entire list of elements and do not modify the individual elements of the list.

The advantages and features of the disclosure and methods of achieving the advantages and features will be described more fully with reference to the accompanying drawings, in which example embodiments of the disclosure are illustrated. The disclosure may, however, be embodied in many different forms and should not be construed as being limited to the example embodiments set forth herein; rather these example embodiments are provided to aid in understanding of the disclosure by one of ordinary skill in the art.

The terms used in this disclosure are general terms currently widely used in the art in consideration of functions in regard to the disclosure, but the terms may vary according to the intention of those of ordinary skill in the art, precedents, or new technology in the art. Also, specified terms may be arbitrarily selected, and in this case, the detailed meaning thereof will be described in the detailed description. Thus, the terms used in the specification should be understood not as simple names but based on the meaning of the terms and the overall description.

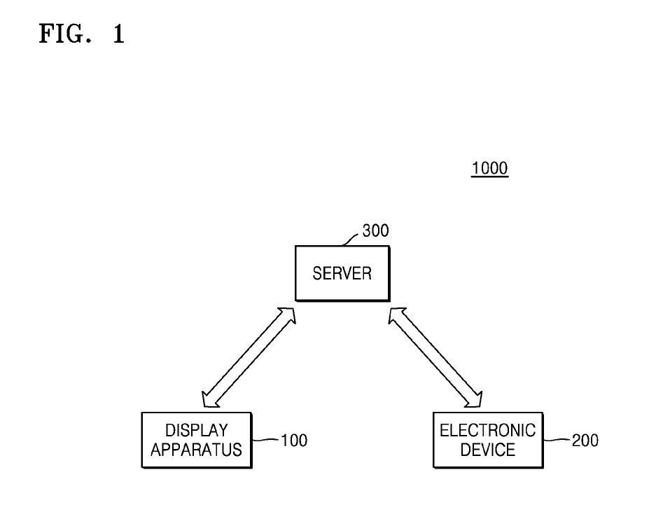

FIG. 1 is a block diagram illustrating an example audience rating survey system 1000.

Referring to FIG. 1, the audience rating survey system 1000 may include, for example, a display apparatus 100, an electronic device 200, and a server 300.

The display apparatus 100 may be an electronic apparatus configured to output content. The display apparatus 100 may, for example, be a smart TV, or the like, but is not limited thereto. Content may, for example, be broadcasting content provided by a terrestrial broadcasting service, a cable broadcasting service, a satellite broadcasting service, or an Internet broadcasting service, or may be video on demand (VOD) content provided by a VOD service, or the like.

The electronic device 200 may be various types of portable or wearable electronic devices. The electronic device 200 may, for example, be any one of a smart phone, a tablet personal computer (PC), a wearable device, a mobile phone, a personal digital assistant (PDA), a laptop device, a media player, a micro server, a global positioning system (GPS) device, an e-book terminal, a digital broadcasting terminal, a navigation device, a kiosk, an MP3 player, a digital camera, or other mobile computing devices, or the like, but is not limited thereto.

While the display apparatus 100 outputs content, a user of the electronic device 200 may watch the content or use the electronic device 200. Only one electronic device 200 is illustrated in FIG. 1, but a plurality of electronic devices may be present around the display apparatus 100 and users of the electronic devices may be different from one another.

The server 300 may, for example, be a computer configured to survey a content audience rating or may, for example, be a non-transitory computer-readable recording medium having recorded thereon an audience rating survey program, or the like. The server 300 may survey the content audience rating by communicating with at least one of the display apparatus 100 and the electronic device 200. The server 300 may communicate with the display apparatus 100 and the electronic device 200 through various communication technologies, including, for example, wired or wireless communication technologies. Only one display apparatus 100 is illustrated in FIG. 1, but the server 300 may communicate with a plurality of display apparatuses.

Hereinafter, an audience rating survey method performed by the audience rating survey system 1000, according to an example embodiment, will be described in greater detail.

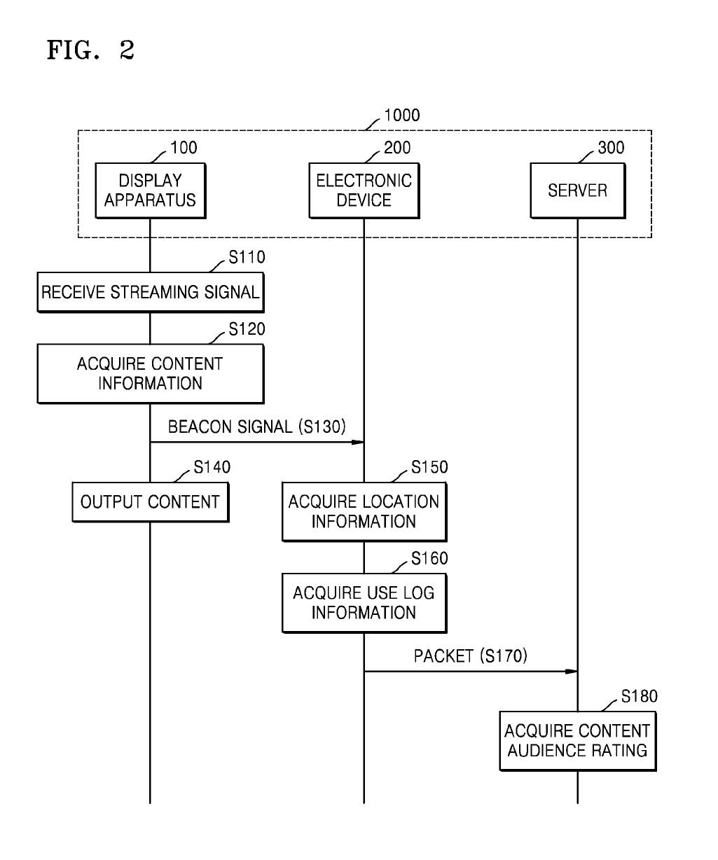

FIG. 2 is a flow diagram illustrating an example audience rating survey method performed by the audience rating survey system 1000.

Referring to FIG. 2, in operation S110, the display apparatus 100 of the audience rating survey system 1000 may receive a streaming signal. The streaming signal may, for example, be a broadcasting signal provided by a terrestrial broadcasting service, a cable broadcasting service, a satellite broadcasting service, or an Internet broadcasting service, or may be a signal provided by a VOD service, or the like.

In operation S120, the display apparatus 100 may acquire content information by, for example, processing the streaming signal. The display apparatus 100 may acquire the content information by parsing the streaming signal. The content information may be information for identifying content such as a program name and a program genre.

The streaming signal may include a header and a payload. The header may include the content information. The payload may include one or more of a video signal and an audio signal for outputting content. The streaming signal may include a transport stream packet of an MPEG-2 system, but is not limited thereto.

In operation S130, the display apparatus 100 may transmit a beacon signal including the content information. The content information may be included in the beacon signal in the form of a specific command or a uniform resource locator (URL). In operation S140, the display apparatus 100 may output the content based on the streaming signal.

The beacon signal may be periodically transmitted through a short-range communication technology. The beacon signal may be transmitted through a Bluetooth technology or a Bluetooth Low Energy (BLE) technology, e.g., the beacon signal may comprise a Bluetooth or BLE signal, but is not limited thereto.

The electronic device 200 may receive the beacon signal transmitted by the display apparatus 100. Any electronic device 200 located within a certain radius from the display apparatus 100 may receive the beacon signal. For example, at least one electronic device 200 may receive the beacon signal. When the beacon signal is transmitted through the BLE technology (e.g., the beacon signal comprises a BLE signal), any electronic device 200 located within the certain radius from the display apparatus 100 may receive the beacon signal without pairing with the display apparatus 100.

In operation S150, the electronic device 200 may acquire location information of the electronic device 200 based on the received beacon signal. The location information of the electronic device 200 may be acquired based on a received signal strength indication (RSSI) of the beacon signal. The beacon signal may include transmission power strength information and the electronic device 200 may acquire the RSSI based on the transmission power strength information and intensity of the received beacon signal. The location information of the electronic device 200 may be information about a distance of the electronic device 200 from the display apparatus 100 or information indicating whether the user of the electronic device 200 is in a location where he/she is capable of watching the display apparatus 100, but is not limited thereto.

The electronic device 200 may receive a beacon signal from at least one beacon, as well as the display apparatus 100. The beacon may be a device configured to periodically generate a beacon signal. At least one beacon may be installed so as to improve the accuracy of the location information of the electronic device 200. The electronic device 200 may acquire the location information of the electronic device 200 based on the beacon signals received from the display apparatus 100 and the at least one beacon.

In operation S160, the electronic device 200 may acquire use log information of the electronic device 200. The use log information may indicate information about use history and use time of the electronic device 200. For example, the use log information may be the use time of a call function, an email function, and applications of the electronic device 200, or the like.

In operation S170, the electronic device 200 may transmit a packet to the server 300, the packet may include, for example, the content information, the location information, and the use log information. Only one electronic device 200 is illustrated in FIG. 2, but the server 300 may receive packets from a plurality of electronic devices, users of which may be different from one another.

In operation S180, the server 300 may acquire a content audience rating by analyzing the received packet. The server 300 may estimate content being watched by each user, based on the content information included in the packet. In this manner, the content audience rating may be acquired.

Additionally, the server 300 may estimate whether the user is in a location where he/she is capable of watching the content and whether the user moves when the display apparatus 100 outputs the content, based on the location information included in the packet.

The server 300 may acquire a variety of additional information by analyzing the packet.

The packet received by the server 300 may further include user information. The user information may include, for example, information about a user's gender, a user's age, and existence or nonexistence of a household member, or the like. The user information may include an identifier of the electronic device 200. The server 300 may store the information about the user's gender, the user's age, and the existence or nonexistence of the household member, which correspond to the identifier of the electronic device 200. The server 300 may analyze attributes of a viewer who watches the content, for example, the viewer's gender and the viewer's age. In addition, the server 300 may estimate whether all household members watch the content or whether only some household members watch the content.

The server 300 may acquire information about the use of the electronic device 200 when the user is watching the content based on the use log information included in the packet. For example, the information about the use of the electronic device 200 may include information indicating whether the user has used the electronic device 200 while watching the electronic device 200 and information indicating functions which the user has used. The server 300 may analyze whether the user has used the electronic device 200 in association with the content. For example, a case where the user uses the electronic device 200 to upload his or her thoughts or feelings about the content on a social network service (SNS) may be considered as use of the electronic device 200 in association with the content. In this manner, the server 300 may estimate a degree of concentration of a viewer watching the content by analyzing the use log information.

The server 300 may use analysis information to provide the display apparatus 100 with an application service, such as a content recommendation service for each individual or household.

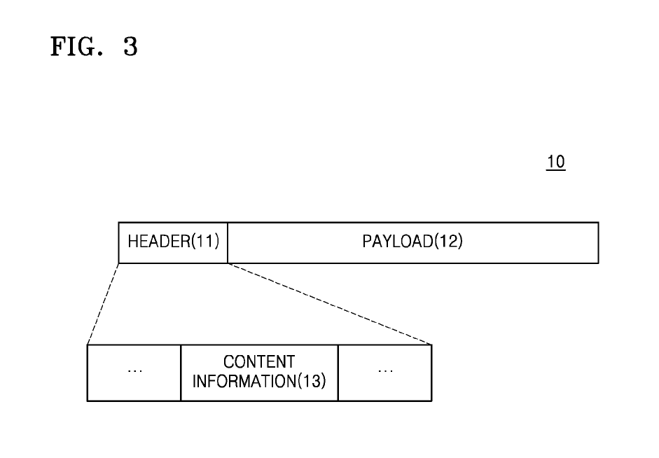

FIG. 3 is a diagram illustrating an example configuration of a streaming signal 10.

Referring to FIG. 3, the streaming signal 10 may include, for example, a header 11 and a payload 12. The header 11 may include content information 13. The content information 13 may, for example, be defined in a specific field among a plurality of fields included in the header 11. The display apparatus 100 of FIG. 2, which receives the streaming signal 10, may extract the content information 13 by parsing the streaming signal 10. The payload 12 may include one or more of a video signal and an audio signal for outputting content. The streaming signal 10 may, for example, be a transport stream packet of the MPEG-2 system, but is not limited thereto.

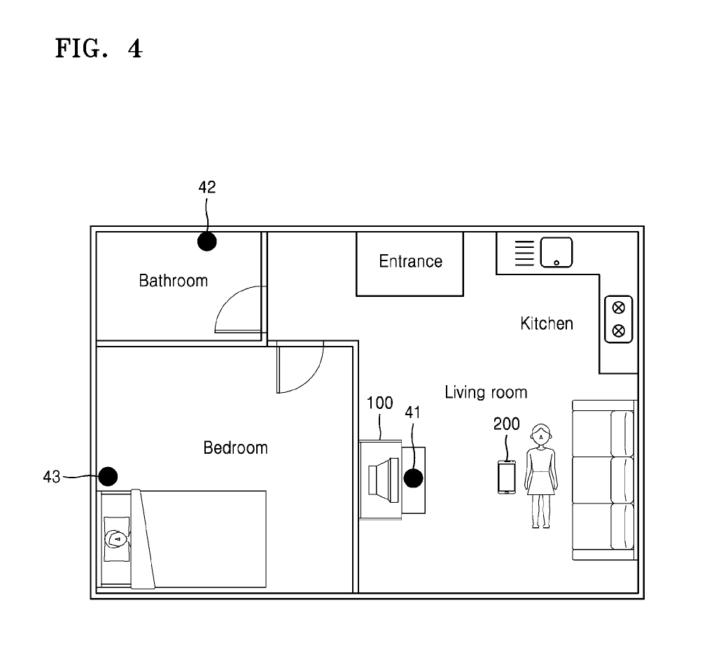

FIG. 4 is a diagram illustrating an installation example of a display apparatus 100 and beacons 42 and 43.

Referring to FIG. 4, the display apparatus 100 includes a beacon 41. The display apparatus 100 and the beacons 42 and 43 may be installed in a household that is subject to an audience rating survey. The beacon 41 may transmit a beacon signal including content information, and the beacons 42 and 43 may transmit second beacon signals. The beacon signal transmitted by the beacon 41 may include content information, but the second beacon signals may not include content information.

The electronic device 200 may receive the beacon signal from the beacon 41 and the second beacon signals from the beacons 42 and 43. The electronic device 200 may acquire location information of the electronic device 200 based on the beacon signal and the second beacon signals.

The installation of the beacons 42 and 43 illustrated in FIG. 4 is only for illustrative purposes. The number of the beacons 42 and 43 is not particularly limited. In addition, the beacons 42 and 43, which are not included in the display apparatus 100, are not necessarily required.

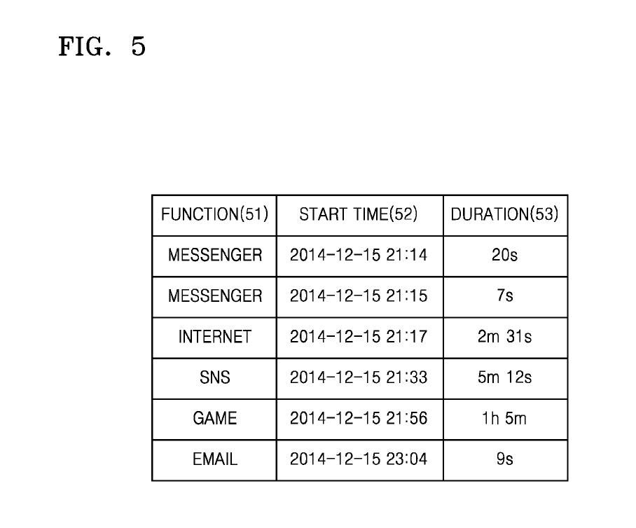

FIG. 5 is a diagram illustrating example use log information of the electronic device 200.

Referring to FIG. 5, the use log information may include, for example, a function 51 of the electronic device 200, a start time 52 of the function 51, and duration 53. The function 51 of the electronic device 200 may include, for example, a messenger, the Internet, an SNS, a game, and an email, or the like. The use log information illustrated in FIG. 5 is only for illustrative purposes and is not limited thereto.

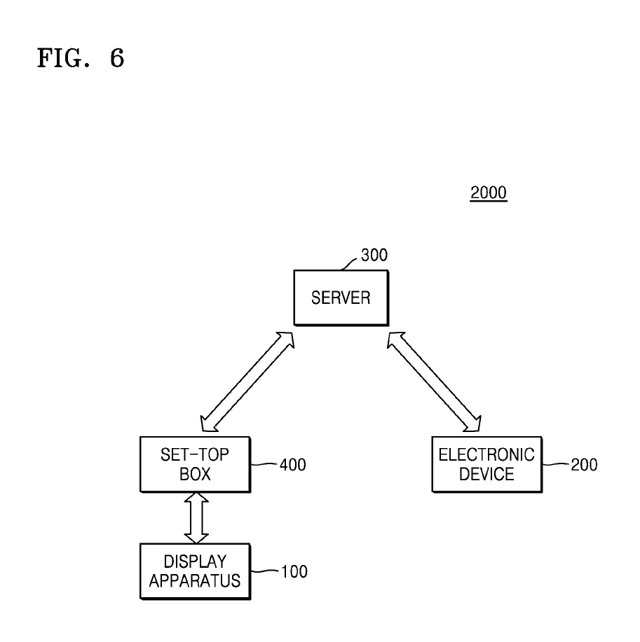

FIG. 6 is a block diagram illustrating an example audience rating survey system 2000.

Referring to FIG. 6, the audience rating survey system 2000 may include, for example, a display apparatus 100, an electronic device 200, a server 300, and a set-top box 400. The audience rating survey system 2000 of FIG. 6 may further include a set-top box 400 in the audience rating survey system 1000 of FIG. 1.

The set-top box 400 may receive a streaming signal from the outside and transmit an audio/visual (AV) signal to the display apparatus 100, the AV signal including, for example, one or more of a video signal and an audio signal based on the streaming signal. The set-top box 400 may be connected to the server 300 and the display apparatus 100 by wire or wirelessly.

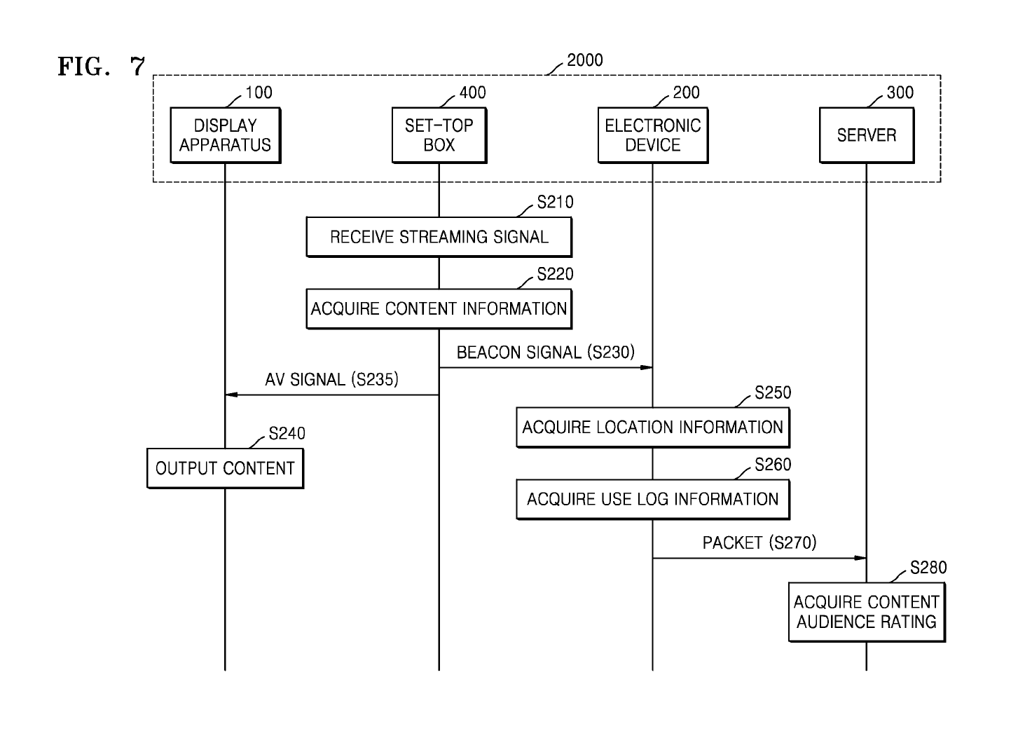

Some operations of the display apparatus 100, which have been described above with reference to FIG. 2, may be performed by the set-top box 400. In addition, the descriptions provided above with reference to FIGS. 1 to 5 may be applied to the audience rating survey system 2000 of FIG. 6. Hereinafter, an audience rating survey method performed by the audience rating survey system 2000, according to an example embodiment, will be described with reference to FIG. 7.

FIG. 7 is flow diagram illustrating an example audience rating survey method.

Referring to FIG. 7, in operation S210, a set-top box 400 of an audience rating survey system 2000 may receive a streaming signal. The streaming signal may, for example, be a broadcasting signal provided by a terrestrial broadcasting service, a cable broadcasting service, a satellite broadcasting service, or an Internet broadcasting service, or may be a signal provided by a VOD service, or the like.

In operation S220, the set-top box 400 may acquire content information by processing the streaming signal. A display apparatus 100 may acquire the content information by parsing the streaming signal. The streaming signal may include a header and a payload. The header may include the content information and the payload may include one or more of a video signal and an audio signal for outputting content. The streaming signal may be a transport stream packet of an MPEG-2 system, but is not limited thereto.

In operation S230, the set-top box 400 may transmit a beacon signal including the content information. The beacon signal may be periodically transmitted through a short-range communication technology. The beacon signal may, for example, be transmitted through a Bluetooth technology or a BLE technology (e.g., the beacon signal may comprise a Bluetooth or BLE signal), but is not limited thereto.

In operation S235, the set-top box 400 may transmit an AV signal acquired based on the streaming signal to the display apparatus 100. In operation S240, the display apparatus 100 may output the content based on the AV signal.

An electronic device 200 may receive the beacon signal transmitted by the set-top box 400. In operation 250, the electronic device 200 may acquire location information of the electronic device 200 based on the received beacon signal. The location information of the electronic device 200 may, for example, be acquired based on an RSSI of the beacon signal.

The electronic device 200 may receive a beacon signal from at least one beacon, as well as the set-top box 400. The electronic device 200 may acquire the location information of the electronic device 200 based on the beacon signals received from the set-top box 400 and the at least one beacon.

In operation S260, the electronic device 200 may acquire use log information of the electronic device 200.

In operation S270, the electronic device 200 may transmit a packet to a server 300, the packet including, for example, the content information, the location information, and the use log information.

In operation S280, the server 300 may acquire a content audience rating by analyzing the received packet. In addition, the server 300 may further acquire information about a viewer's attributes and a degree of concentration of a viewer, as well as the audience rating, by analyzing the received packet. Since these have been described above with reference to FIG. 2, redundant descriptions thereof will not be repeated here.

The server 300 may use analysis information to provide the display apparatus 100 with an application service, such as a content recommendation service for each individual or household.

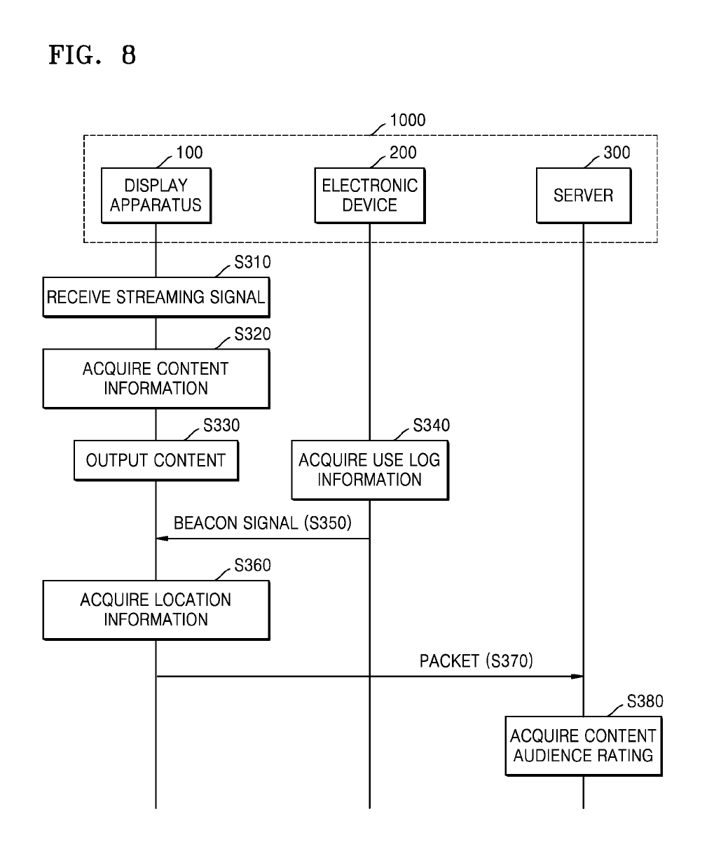

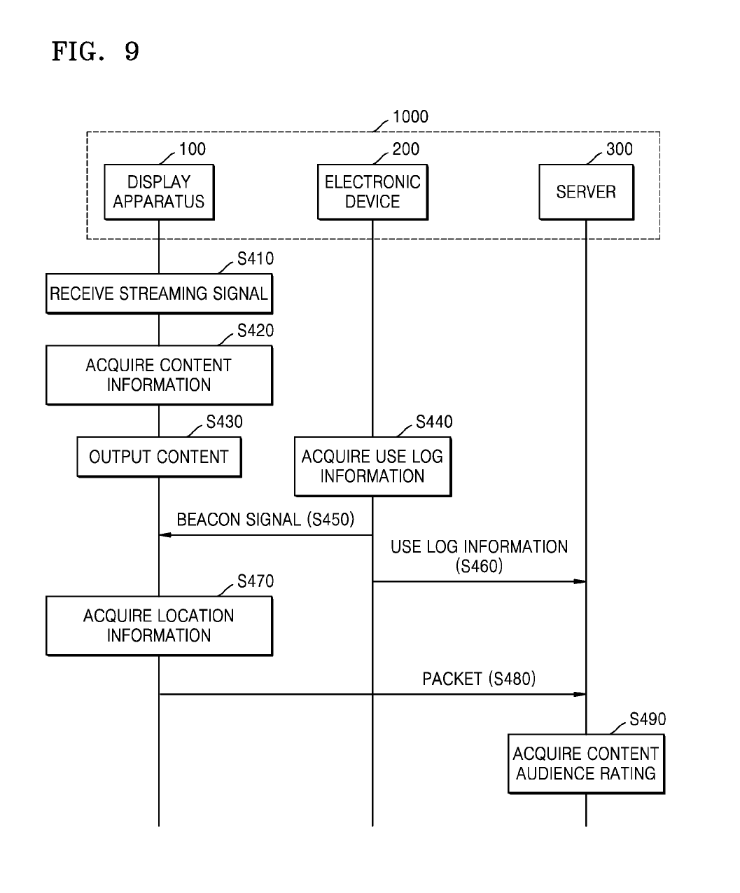

The example where the electronic device 200 receives the beacon signal transmitted by the display apparatus 100 or the set-top box 400 has been described. However, it is possible to survey the content audience rating even in a case where the electronic device 200 transmits the beacon signal. Hereinafter, this example will be described in detail with reference to FIGS. 8 and 9.

FIG. 8 is flow diagram illustrating an example audience rating survey method.

Referring to FIG. 8, in operation S310, a display apparatus 100 of an audience rating survey system 1000 may receive a streaming signal. In operation S320, the display apparatus 100 may acquire content information by processing the streaming signal. The display apparatus 100 may extract the content information by, for example, parsing the streaming signal.

The streaming signal may include a header and a payload. The header may include the content information. The payload may include one or more of a video signal and an audio signal for content output. The streaming signal may be a transport stream packet of an MPEG-2 system, but is not limited thereto.

In operation S330, the display apparatus 100 may output the content based on the streaming signal.

In operation S340, an electronic device 200 may acquire use log information.

In operation S350, the electronic device 200 may transmit a beacon signal including the use log information. The beacon signal may further include user information. The user information may include, for example, a user's gender, a user's age, and existence or nonexistence of a household member. The user information may include, for example, an identifier of the electronic device 200. At least one of the display apparatus 100 and a server 300 may store the information about the user's gender, the user's age, and the existence or nonexistence of the household member, which correspond to the identifier of the electronic device 200.

The beacon signal may be periodically transmitted through a short-range communication technology. The beacon signal may be transmitted through a Bluetooth technology or a Bluetooth Low Energy (BLE) technology (e.g., the beacon signal may comprise a BLE signal), but is not limited thereto.

The display apparatus 100 may receive the beacon signal transmitted by the electronic device 200. Since the beacon signal is periodically transmitted, the display apparatus 100 may receive the beacon signal even in a screen-off state in which the display apparatus 100 does not output the content. The display apparatus 100 may not receive the beacon signal in the screen-off state.

In operation S360, the display apparatus 100 may acquire location information of the electronic device 200 based on the received beacon signal. The location information of the electronic device 200 may be acquired based on an RSSI of the beacon signal.

In operation S370, the display apparatus 100 may transmit a packet to a server 300, the packet including, for example, the content information acquired from the streaming signal, the location information acquired from the beacon signal, and the use log information included in the beacon signal. The packet may further include user information included in the beacon signal.

In operation S380, the server 300 may acquire a content audience rating by analyzing the received packet. In addition, the server 300 may further acquire information about a viewer's attributes and a degree of concentration of a viewer, as well as the audience rating, by analyzing the received packet. The server 300 may use analysis information to provide the display apparatus 100 with an application service, such as a content recommendation service for each individual or household. Since these have been described above with reference to FIG. 2, redundant descriptions thereof will not be repeated.

In a case where the set-top box (400 of FIG. 6) is connected to the display apparatus 100, the operations of the display apparatus 100 illustrated in FIG. 8, except for operation S330 of outputting the content, may be performed by the set-top box 400. For example, the set-top box 400 may receive the streaming signal, acquire the content information, and transmit the AV signal based on the streaming signal to the display apparatus 100. The set-top box 400 may receive the beacon signal including the use log information from the electronic device 200 and acquire the location information of the electronic device 200. The set-top box 400 may transmit the packet to the server 300, the packet including the content information, the location information, and the use log information. In addition, the set-top box 400 may receive the application service, such as the content recommendation service for each individual or household, from the server 300.

FIG. 9 is flow diagram illustrating an example audience rating survey method.

Referring to FIG. 9, in operation S410, a display apparatus 100 of an audience rating survey system 1000 may receive a streaming signal. In operation S420, the display apparatus 100 may acquire content information by processing the streaming signal. In operation S430, the display apparatus 100 may output content based on the streaming signal.

In operation S440, an electronic device 200 may acquire use log information.

In operation S450, the electronic device 200 may transmit a beacon signal. In operation S460, the electronic device 200 may transmit the use log information to a server 300. In FIG. 8, the beacon signal including the use log information is transmitted to the display apparatus 100, whereas in FIG. 9, the use log information may be transmitted from the electronic device 200 to the server 300. Unlike in FIG. 8, the beacon signal of FIG. 9 may not include the use log information.

The display apparatus 100 may receive the beacon signal transmitted by the electronic device 200.

In operation S470, the display apparatus 100 may acquire location information of the electronic device 200 based on the received beacon signal. The location information of the electronic device 200 may be acquired based on an RSSI of the beacon signal.

In operation S480, the display apparatus 100 may transmit a packet to the server 300, the packet including the content information acquired from the streaming signal and the location information acquired from the beacon signal. The packet may further include user information included in the beacon signal.

In operation S490, the server 300 may acquire a content audience rating by analyzing the received packet. In addition, the server 300 may estimate a degree of concentration of a viewer watching the content by analyzing the received packet and the use log information.

Since operations of FIG. 9 are substantially identical to operations of FIG. 8, except for operation S450 of transmitting the beacon signal and operation S460 of transmitting the use log information, redundant descriptions thereof will not be repeated.

In addition, as described above with reference to FIG. 8, in a case where the set-top box (400 of FIG. 6) is connected to the display apparatus 100, the operations of the display apparatus 100 illustrated in FIG. 9, except for operation S430 of outputting the content, may be performed by the set-top box 400. For example, the set-top box 400 may receive the streaming signal, acquire the content information, and transmit the AV signal based on the streaming signal to the display apparatus 100. The set-top box 400 may receive the beacon signal from the electronic device 200 and acquire the location information of the electronic device 200. The set-top box 400 may transmit the packet to the server 300, the packet including the content information and the location information. In addition, the set-top box 400 may receive the application service, such as the content recommendation service for each individual or household, from the server 300.

The case where the electronic device 200 transmits the beacon signal has been described with reference to FIGS. 8 and 9. However, according to various example embodiments, a beacon device separated from the electronic device 200 may transmit the beacon signal. The beacon device is a device configured to periodically transmit the beacon signal through a short-range communication technology. The beacon device may transmit the beacon signal through a Bluetooth technology and a BLE technology (e.g., the beacon signal may comprise a BLE signal), but is not limited thereto. The beacon device may be portable or wearable by a user. In addition, the beacon device may be installed in a user's body. Therefore, beacon devices may respectively correspond to users. The beacon signal may include user information of the beacon device so as to identify the user of the beacon device. Hereinafter, a case where a beacon device separated from the electronic device 200 is present will be described below.

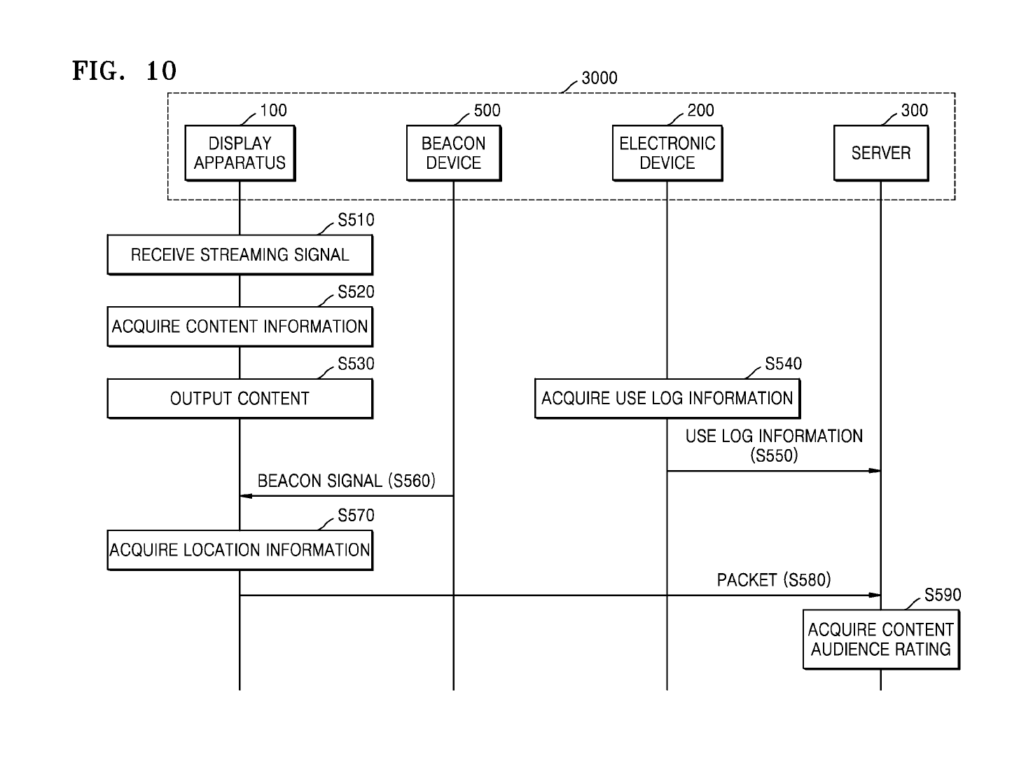

FIG. 10 is flow diagram illustrating an example audience rating survey method.

Referring to FIG. 10, an audience rating survey system 3000 may include, for example, a display apparatus 100, an electronic device 200, a server 300, and a beacon device 500. A user of the electronic device 200 and a user of the beacon device 500 may be the same person.

In operation S510, the display apparatus 100 may receive a streaming signal. In operation S520, the display apparatus 100 may acquire content information by processing the streaming signal. In operation S530, the display apparatus 100 may output content based on the streaming signal.

In operation S540, the electronic device 200 may acquire use log information. In operation S550, the electronic device 200 may transmit the use log information to the server 300.

In operation S560, the beacon device 500 may transmit a beacon signal. The beacon signal may include, for example, user information. The user information may include information about a user's gender, a user's age, and existence or nonexistence of a household member. The user information may include an identifier of the beacon device 500. At least one of the display apparatus 100 and the server 300 may store the information about the user's gender, the user's age, and the existence or nonexistence of the household member, which correspond to the identifier of the beacon device 500.

The display apparatus 100 may receive the beacon signal transmitted by the beacon device 500.

In operation S570, the display apparatus 100 may acquire location information of the beacon device 500 based on the received beacon signal. The location information of the beacon device 500 may be acquired based on an RSSI of the beacon signal. The location information of the beacon device 500 may be information about a distance of the beacon device 500 from the display apparatus 100 or information indicating whether the user of the beacon device 500 is in a position where he/she is capable of watching the display apparatus 100, but is not limited thereto.

In operation S580, the display apparatus 100 may transmit a packet to the server 300, the packet including the content information acquired from the streaming signal and the location information acquired from the beacon signal. The packet may further include the user information included in the beacon signal.

In operation S590, the server 300 may acquire a content audience rating by analyzing the received packet. In addition, the server 300 may estimate a degree of concentration of a viewer watching the content by analyzing the received packet and the use log information.

The descriptions provided above with reference to FIGS. 1 to 9 may be applied to the display apparatus 100, the electronic device 200, and the server 300. In addition, when the set-top box (400 of FIG. 6) is connected to the display apparatus 100, the operations of the display apparatus 100 illustrated in FIG. 10, except for operation S530 of outputting the content, may be performed by the set-top box 400.

In FIG. 10, the case where the electronic device 200 is separated from the beacon device 500 has been described. The beacon device 500 of FIG. 10 may be an independent device or may be embedded in a wearable device.

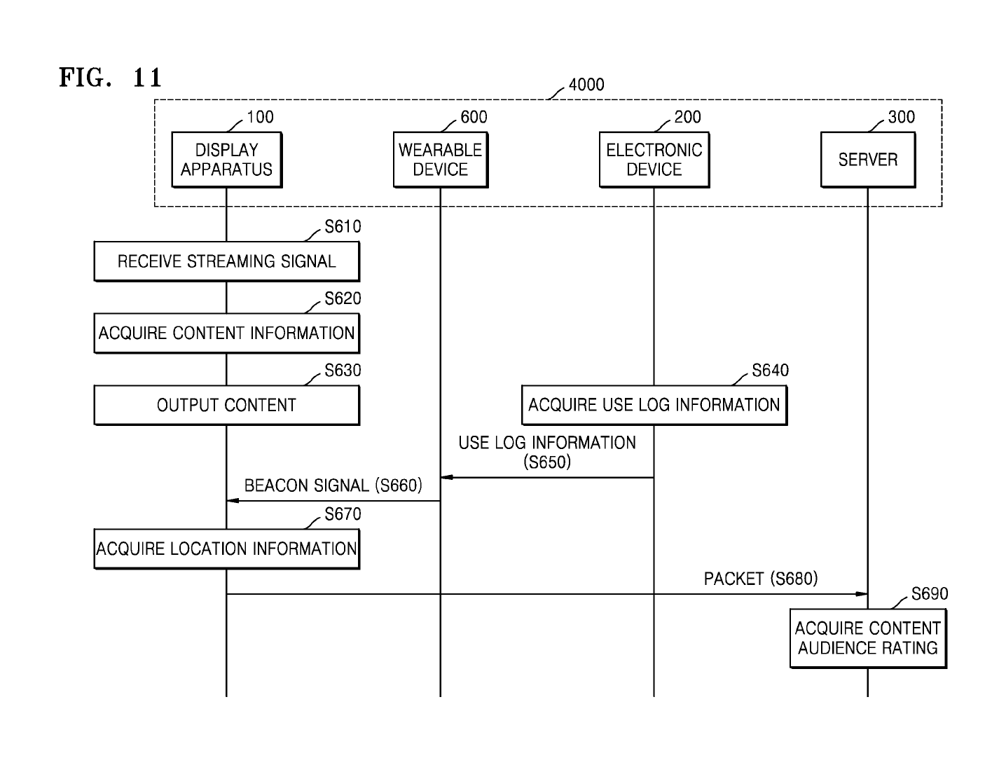

In a case where the beacon device 500 is embedded in the wearable device, an audience rating survey method may be performed according to the following example embodiment of FIG. 11.

FIG. 11 is flow diagram illustrating an example audience rating survey method.

Referring to FIG. 11, an audience rating survey system 4000 may include, for example, a display apparatus 100, an electronic device 200, a server 300, and a wearable device 600. The wearable device 600 may include a beacon device configured to periodically transmit a beacon signal. A user of the electronic device 200 and a user of the wearable device 600 may be the same person.

In operation S610, the display apparatus 100 may receive a streaming signal. In operation S620, the display apparatus 100 may acquire content information by processing the streaming signal. In operation S630, the display apparatus 100 may output content based on the streaming signal.

In operation S640, the electronic device 200 may acquire use log information. In operation S650, the electronic device 200 may transmit the use log information to the wearable device 600.

In operation S660, the wearable device 600 may transmit a beacon signal including the use log information to the display apparatus 100. The beacon signal may further include user information. The display apparatus 100 may receive the beacon signal transmitted by the wearable device 600.

In operation S670, the display apparatus 100 may acquire location information of the wearable device 600 based on the received beacon signal. The location information of the wearable device 600 may be acquired based on an RSSI of the beacon signal. The location information of the wearable device 600 may be information about a distance of the wearable device 600 from the display apparatus 100 or information indicating the user of the wearable device 600 is in a location where he/she is capable of watching the display apparatus 100, but is not limited thereto.

In operation S680, the display apparatus 100 may transmit a packet to the server 300, the packet including the content information acquired from the streaming signal, the location information acquired from the beacon signal, and the use log information included in the beacon signal. The packet may further include the user information included in the beacon signal.

In operation S690, the server 300 may acquire a content audience rating by analyzing the received packet. In addition, the server 300 may estimate a viewer's attributes and a degree of concentration of a viewer watching the content.

The descriptions provided above with reference to FIGS. 1 to 10 may be applied to the display apparatus 100, the electronic device 200, and the server 300 of FIG. 11. In addition, in a case where the set-top box (400 of FIG. 6) is connected to the display apparatus 100, the operations of the display apparatus 100 illustrated in FIG. 11, except for operation S630 of outputting the content, may be performed by the set-top box 400.

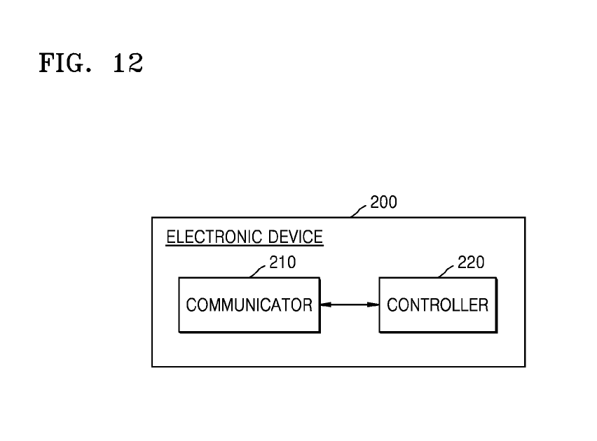

FIG. 12 is a block diagram illustrating an example electronic device 200.

Referring to FIG. 12, the electronic device 200 may include a communicator (e.g., including communication circuitry) 210 and a controller (e.g., including processing circuitry) 220.

The communicator 210 may be configured to allow the electronic device 200 to communicate with various external devices, such as a display apparatus, a set-top box, and a server, using various communication methods. The communicator 210 may include a short-range communication module, a wired communication module, a wireless communication module, and a mobile communication module, or the like.

The short-range communication module may be configured to perform short-range communication with a device located within a certain distance. Examples of the short-range communication technology may include a wireless local area network (LAN), wireless fidelity (Wi-Fi), Bluetooth, Zigbee, Wi-Fi direct (WFD), ultra wideband (UWB), infrared data association (IrDA), BLE, and near field communication (NFC), or the like, but are not limited thereto.

The wired communication module may be configured to perform communication by using an electrical signal or an optical signal. Examples of the wired communication technology may include wired communication technologies using a pair cable, a coaxial cable, and an optical fiber cable and may include wired communication technologies apparent to those of ordinary skill in the art.

The wireless communication module may be configured to transmit and receive a wireless signal to and from at least one of a base station, an external device, and a server via a mobile communication network. Examples of the wireless signal may include various types of data for transmission and reception of voice call signals, video call signals, or text/multimedia messages, or the like.

The controller 220 may be configured to control an overall operation of the electronic device 200 and to process various data necessary for the operation of the electronic device 200. The control of the operation of the electronic device 200 or the data processing necessary for the operation of the electronic device 200, which have been described above with reference to the drawings, may be performed by the controller 220. The controller 200 may be variously implemented by, for example, a central processing unit (CPU), a microprocessor, or a graphic processing unit (GPU), or the like.

The controller 220 may be configured to receive a beacon signal including content information by controlling the communicator 210. The controller 220 may be configured to receive the beacon signal from a display apparatus or a set-top box connected to the display apparatus. The beacon signal may be received through a short-range communication technology, such as a Bluetooth technology or a BLE technology (e.g., the beacon signal may comprise a BLE signal). In a case where the beacon signal is transmitted through the BLE technology, the controller 220 may be configured to receive the beacon signal without pairing with the display apparatus or the set-top box.

The controller 220 may be configured to acquire location information of the electronic device 200 based on the beacon signal. The controller 220 may be configured to acquire the location information of the electronic device 200 based on an RSSI of the beacon signal. The controller 220 may be configured to receive a beacon signal from the display apparatus or the set-top box and to further receive a second beacon signal from at least one beacon. The controller 220 may be configured to acquire the location information of the electronic device 200 based on the beacon signal and the second beacon signal.

The controller 220 may be configured to acquire use log information of the electronic device 200. The controller 220 may be configured to control the communicator 210 to transmit a packet to the server, the packet including the content information, the location information, and the use log information.

According to various example embodiments, the controller 220 may be configured to transmit a beacon signal including the use log information.

According to various example embodiments, the controller 220 may be configured to periodically transmit the beacon signal and transmit the use log information to the server.

According to various example embodiments, the electronic device 200 may transmit the use log information to a wearable device including the beacon device or the server.

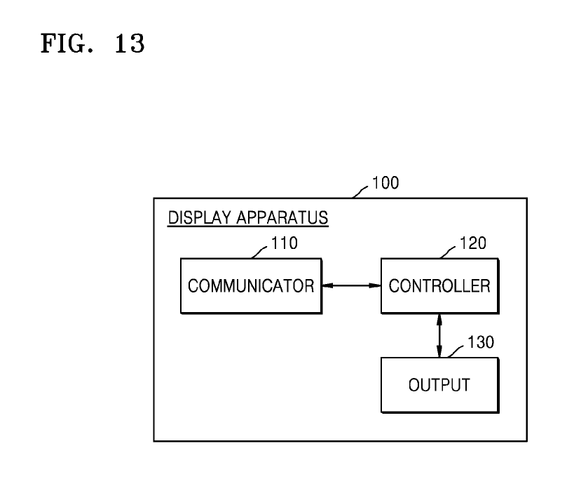

FIG. 13 is a block diagram illustrating an example display apparatus 100.

Referring to FIG. 13, the display apparatus 100 may include, for example, a communicator (e.g., including communication circuitry) 110, a controller (e.g., including processing circuitry) 120, and an output (e.g., including output circuitry) 130. The communicator 110 may be configured to allow the display apparatus 100 to communicate with various external devices, such as an electronic device, a set-top box, and a server 300, using various communication methods. The communicator 110 may include a short-range communication module, a wired communication module, a wireless communication module, and a mobile communication module, or the like.

The short-range communication module may be configured to perform short-range communication with a device located within a certain distance. Examples of the short-range communication technology may include a wireless LAN, Wi-Fi, Bluetooth, Zigbee, WFD, UWB, IrDA, BLE, and NFC, or the like, but are not limited thereto.

The wired communication module may be configured to perform communication using an electrical signal or an optical signal. Examples of the wired communication technology may include wired communication technologies using a pair cable, a coaxial cable, and an optical fiber cable and may include wired communication technologies apparent to those of ordinary skill in the art.

The wireless communication module may be configured to transmit and receive a wireless signal to and from at least one of a base station, an external device, and a server via a mobile communication network. Examples of the wireless signal may include various types of data for transmission and reception of voice call signals, video call signals, or text/multimedia messages, or the like.

The controller 120 may be configured to control an overall operation of the display apparatus 100 and to process various data necessary for the operation of the display apparatus 100. The control of the operation of the display apparatus 100 or the data processing necessary for the operation of the display apparatus 100, which has been described above with reference to the drawings, may be performed by the controller 120. The controller 120 may be variously implemented by, for example, a CPU, a microprocessor, or a GPU, or the like.

The output 130 may output content. The output 130 may include a display configured to output a video signal and a speaker configured to output an audio signal.

The controller 120 may be configured to receive a streaming signal by controlling the communicator 110. The streaming signal may be a broadcasting signal provided by a terrestrial broadcasting service, a cable broadcasting service, a satellite broadcasting service, or an Internet broadcasting service, or may be a signal provided by a VOD service, or the like.

The controller 120 may be configured to acquire content information by processing the streaming signal. The controller 120 may be configured to extract the content information by parsing the streaming signal. The streaming signal may include a header and a payload. The header may include the content information and the payload may include one or more of a video signal and an audio signal for content output. The streaming signal may be a transport stream packet of an MPEG-2 system, but is not limited thereto.

The controller 120 may be configured to transmit a beacon signal including the content information. In addition, the controller 120 may be configured to control the output 130 to output the content based on the streaming signal.

The controller 120 may be configured to periodically transmit the beacon signal. The controller 120 may be configured to transmit the beacon signal through a short-range communication technology.

According to various example embodiments, the controller 120 may be configured to not transmit the beacon signal including the content information and may receive the beacon signal from the electronic device. The controller 120 may be configured to acquire location information of the electronic device based on the beacon signal. The controller 120 may be configured to acquire the location information of the electronic device based on an RSSI of the beacon signal. The controller 120 may be configured to transmit a packet to a server, the packet including the content information and the location information. The received beacon signal may include use log information. In this example, the packet may further include the use log information. The controller 120 may be configured to receive an application service, such as a content recommendation service for each individual or household, from the server.

According to various example embodiments, the controller 120 may be configured to receive an AV signal from a set-top box and output content based on the AV signal.

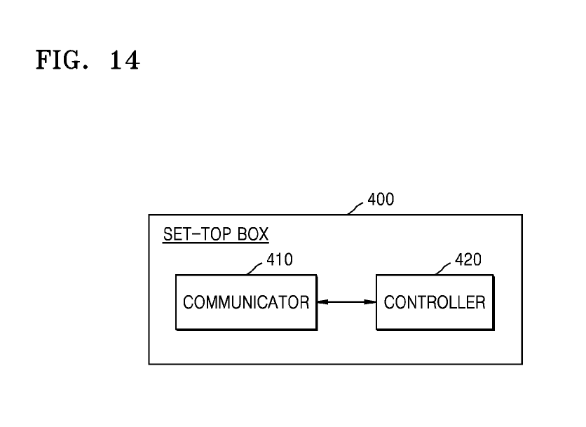

FIG. 14 is a block diagram illustrating an example set-top box 400.

Referring to FIG. 14, the set-top box 400 may include, for example, a communicator (e.g., including communication circuitry) 410 and a controller (e.g., including processing circuitry) 420.

The communicator 410 may be configured to allow the set-top box 400 to communicate with various external devices, such as an electronic device, a display apparatus, and a server, using various methods. The communicator 410 may include a short-range communication module, a wired communication module, a wireless communication module, and a mobile communication module.

The short-range communication module may be configured to perform short-range communication with a device located within a certain distance. Examples of the short-range communication technology may include a wireless LAN, Wi-Fi, Bluetooth, Zigbee, WFD, UWB, IrDA, BLE, and NFC, or the like, but are not limited thereto.

The wired communication module may be configured to perform communication by using an electrical signal or an optical signal. Examples of the wired communication technology may include wired communication technologies using a pair cable, a coaxial cable, and an optical fiber cable and may include wired communication technologies apparent to those of ordinary skill in the art.

The wireless communication module may be configured to transmit and receive a wireless signal to and from at least one of a base station, an external device, and a server via a mobile communication network. Examples of the wireless signal may include various types of data for transmission and reception of voice call signals, video call signals, or text/multimedia messages, or the like.

The controller 420 may be configured to control an overall operation of the set-top box 400 and to process various data necessary for the operation of the set-top box 400. The control of the operation of the set-top box 400 or the data processing necessary for the operation of the set-top box 400, which have been described above with reference to the drawings, may be performed by the controller 420. The controller 420 may be variously implemented by, for example, a CPU, a microprocessor, or a GPU, or the like.

The controller 420 may be configured to receive a streaming signal by controlling the communicator 410. The streaming signal may be a broadcasting signal provided by a terrestrial broadcasting service, a cable broadcasting service, a satellite broadcasting service, or an Internet broadcasting service, or may be a signal provided by a VOD service, or the like.

The controller 420 may be configured to acquire content information by processing the streaming signal. The controller 420 may be configured to extract the content information by parsing the streaming signal. The streaming signal may include a header and a payload. The header may include the content information and the payload may include at least one of a video signal and an audio signal for content output. The streaming signal may be a transport stream packet of an MPEG-2 system, but is not limited thereto.

The controller 420 may be configured to transmit a beacon signal including the content information. In addition, the controller 420 may be configured to transmit one or more of the video signal and the audio signal to the display apparatus. The controller 420 may be configured to periodically transmit the beacon signal. The controller 420 may be configured to transmit the beacon signal through a short-range communication technology.

According to various example embodiments, the controller 420 may be configured to not transmit the beacon signal including the content information and may be configured to receive the beacon signal from the electronic device. The controller 420 may be configured to acquire location information of the electronic device based on the beacon signal. The controller 420 may be configured to acquire the location information of the electronic device based on an RSSI of the beacon signal. The controller 420 may be configured to transmit a packet to a server, the packet including the content information and the location information. The received beacon signal may include use log information. In this example, the packet may further include the use log information. The controller 420 may be configured to receive an application service, such as a content recommendation service for each individual or household, from the server.

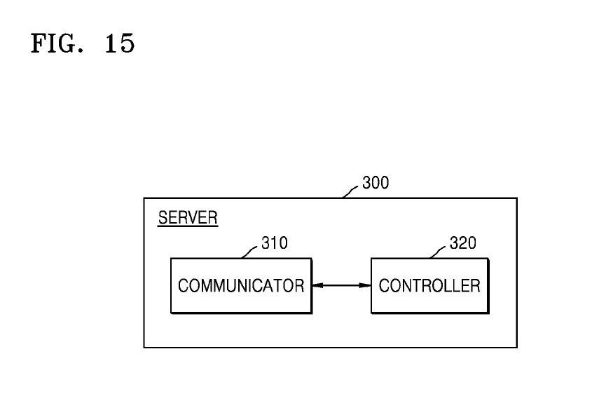

FIG. 15 is a block diagram illustrating an example server 300.

Referring to FIG. 15, the server 300 may include, for example, a communicator (e.g., including communication circuitry) 310 and a controller (e.g., including processing circuitry) 320.

The communicator 310 may be configured to allow the server 300 to communicate with various external devices, such as a display apparatus, a set-top box, and an electronic device, using various methods. The communicator 310 may include a short-range communication module, a wired communication module, a wireless communication module, and a mobile communication module.

The short-range communication module may be configured to perform short-range communication with a device located within a certain distance. Examples of the short-range communication technology may include a wireless LAN, Wi-Fi, Bluetooth, Zigbee, WFD, UWB, IrDA, BLE, and NFC, or the like but are not limited thereto.

The wired communication module may be configured to perform communication by using an electrical signal or an optical signal. Examples of the wired communication technology may include wired communication technologies using a pair cable, a coaxial cable, and an optical fiber cable and may include wired communication technologies apparent to those of ordinary skill in the art.

The wireless communication module may be configured to transmit and receive a wireless signal to and from at least one of a base station, an external device, and a server via a mobile communication network. Examples of the wireless signal may include various types of data for transmission and reception of voice call signals, video call signals, or text/multimedia messages, or the like.

The controller 320 may be configured to control an overall operation of the server 300 and to process various data necessary for the operation of the server 300. The control of the operation of the server 300 or the data processing necessary for the operation of the server 300, which have been described above with reference to the drawings, may be performed by the controller 320. The controller 320 may be variously implemented by, for example, a CPU, a microprocessor, or a GPU, or the like.

The controller 320 may be configured to control the communicator 310 to receive a packet, which includes content information, location information of the electronic device, and use log information of the electronic device, from at least one of the electronic device, the display apparatus, and the set-top box. The controller 320 may be configured to control the communicator 310 to receive a packet, which includes the content information and the location information of the electronic device, from the display apparatus or the set-top box and receive the use log information from the electronic device.

The controller 320 may be configured to acquire a variety of information, such as a content audience rating, a viewer's attributes, and a degree of concentration of a viewer, by analyzing the packet and the use log information. In addition, the controller 320 may be configured to provide the display apparatus or the set-top box with an application service, such as a content recommendation service for each individual or household.

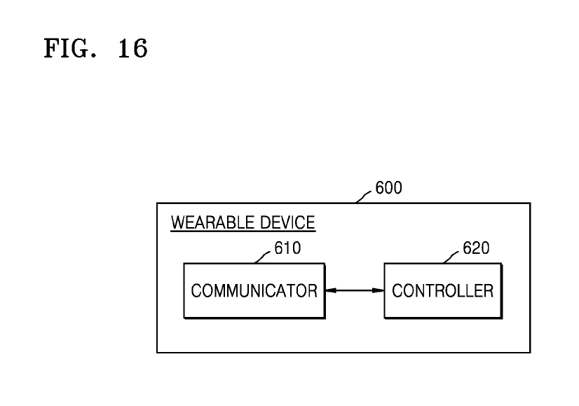

FIG. 16 is a block diagram illustrating an example wearable device 600.

Referring to FIG. 16, the wearable device 600 may include, for example, a communicator (e.g., including communication circuitry) 610 and a controller (e.g., including processing circuitry) 620.

The communicator 610 may include a beacon device configured to periodically transmit a beacon signal. In addition, the communicator 610 may be configured to allow the wearable device 600 to communicate with various external devices, such as a display apparatus, a set-top box, an electronic device, and a server, using various methods. The communicator 610 may include a short-range communication module, a wired communication module, a wireless communication module, and a mobile communication module.

The short-range communication module may be configured to perform short-range communication with a device located within a certain distance. Examples of the short-range communication technology may include a wireless LAN, Wi-Fi, Bluetooth, Zigbee, WFD, UWB, IrDA, BLE, and NFC, or the like, but are not limited thereto.

The wired communication module may be configured to perform communication using an electrical signal or an optical signal. Examples of the wired communication technology may include wired communication technologies using a pair cable, a coaxial cable, and an optical fiber cable and may include wired communication technologies apparent to those of ordinary skill in the art.

The wireless communication module may be configured to transmit and receive a wireless signal to and from at least one of a base station, an external device, and a server via a mobile communication network. Examples of the wireless signal may include various types of data for transmission and reception of voice call signals, video call signals, or text/multimedia messages, or the like.

The controller 620 may be configured to control an overall operation of the wearable device 600 and to process various data necessary for the operation of the wearable device 600. The control of the operation of the wearable device 600 or the data processing necessary for the operation of the wearable device 600, which have been described above with reference to the drawings, may be performed by the controller 620. The controller 620 may be variously implemented by, for example, a CPU, a microprocessor, or a GPU, or the like.

The controller 620 may be configured to control the communicator 610 to receive use log information from the electronic device. The controller 620 may be configured to periodically transmit a beacon signal including the use log information.

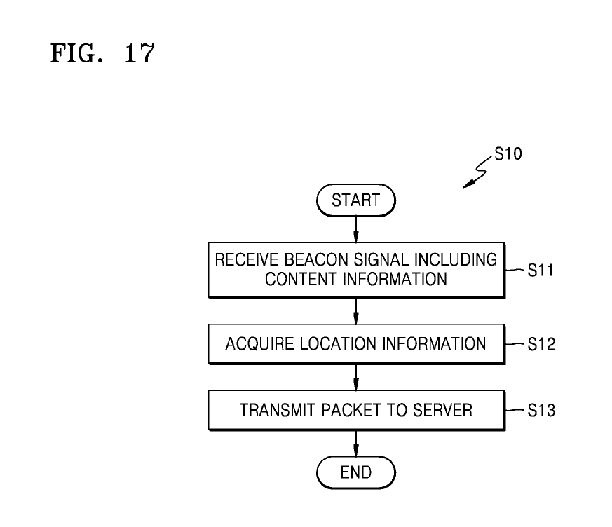

FIG. 17 is a flowchart illustrating an example method S10 of operating an electronic device.

Referring to FIG. 17, in operation S11, the electronic device may receive a beacon signal including content information. The electronic device may receive the beacon signal from a display apparatus or a set-top box connected to the display apparatus. The beacon signal may be received through a short-range communication technology, such as a Bluetooth technology and a BLE technology (e.g., the beacon signal may comprise a BLE signal). In a case where the beacon signal is transmitted through the BLE technology, the electronic device may receive the beacon signal without pairing with the display apparatus or the set-top box.

In operation S12, the electronic device may acquire location information of the electronic device based on the beacon signal. The electronic device may acquire the location information based on an RSSI of the beacon signal. The controller may be configured to receive a beacon signal from the display apparatus or the set-top box and further receive a second beacon signal from at least one beacon. The electronic device may acquire the location information of the electronic device based on the beacon signal and the second beacon signal.

In operation S13, the electronic device may transmit a packet to a server, the packet including the content information, the location information, and the use log information.

The method S10 of operating the electronic device, which has been described above with reference to FIG. 17, may be performed by the above-described electronic devices 200. The above descriptions provided with reference to the drawings may be applied to the operation S10 of operating the electronic device.

As such, according to various example embodiments, it is possible to provide an efficient and reliable content audience rating survey method. The server may acquire the content audience rating in real time and provide the application service such as the content recommendation service for each individual or household. In addition to the content audience rating, the server may estimate whether a viewer is in a location where he/she is capable of watching the content, based on the location information, thus improving the accuracy of the audience rating. The server may detect the number of viewers watching one display apparatus. In addition, the server may acquire information indicating whether a viewer performs multitasking, based on the use log information of the electronic device, and may acquire information about a degree of concentration of a viewer watching the content.

In the audience rating survey methods according to various example embodiments, the display apparatus, the electronic device, and the server may automatically communicate with one another without any user intervention, thus improving user convenience. In the case of a people meter that is an existing audience rating survey device, it is inconvenient for a user to input several items into the people meter.

The audience rating survey methods according to various example embodiments may improve viewer convenience and satisfaction of the viewer receiving the application service for each individual. In addition, the server may reliably acquire a variety of information, such as the content audience rating, the viewer's attributes, and the degree of concentration of the viewer, thus providing an improved business model.

The above-described example embodiments may be embodied by computer programs and may be implemented by using general-purpose digital computers that execute the programs using a non-transitory computer-readable recording medium.

Examples of the non-transitory computer-readable recording medium may include magnetic storage media (e.g., ROM, floppy disks, hard disks, etc.), and optical recording media (e.g., CD-ROMs, DVDs, etc.).

It should be understood that example embodiments described herein should be considered in a descriptive sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope as defined by the following claims.

What is claimed is:

1. An electronic device comprising:
a communicator comprising communication circuitry; and
a controller configured to control the communicator to receive a beacon signal including content information, to acquire location information based on the beacon signal, and to transmit a packet to a server, the packet including the content information, the location information, and use log information.

2. The electronic device of claim 1, wherein the controller is configured to acquire the location information based on a received signal strength indication (RSSI) of the beacon signal.

3. The electronic device of claim 1, wherein the controller is configured to receive the beacon signal comprising a Bluetooth Low Energy (BLE) signal.

4. The electronic device of claim 1, wherein the controller is configured to receive the beacon signal from one or more of a display apparatus or a set-top box connected to the display apparatus.

5. The electronic device of claim 4, wherein the controller is configured to receive a second beacon signal from at least one beacon and to acquire the location information based on the beacon signal and the second beacon signal.

6. A display apparatus comprising:
a communicator comprising communication circuitry; and
a controller configured to control the communicator to receive a streaming signal, to receive a beacon signal from an electronic device, the beacon signal including user information and use log information, and to transmit a packet to a server, the packet including content information acquired by parsing the streaming signal, the user information, and the use log information.

7. The display apparatus of claim 6, wherein the streaming signal comprises a broadcasting signal or a signal provided by a video on demand (VOD) service.

8. The display apparatus of claim 6, wherein the streaming signal comprises a header and a payload, wherein
the header includes content information, and
the payload includes one or more of a video signal and an audio signal.

9. The display apparatus of claim 8, wherein the streaming signal comprises a transport stream packet.

10. The display apparatus of claim 8, further comprising an output comprising output circuitry, the output configured to output at least one of the video signal and the audio signal.

11. The display apparatus of claim 6, wherein the controller is configured to receive a content recommendation service from the server.

12. The display apparatus of claim 6, wherein the controller is configured to acquire location information of the electronic device based on a received signal strength indication (RSSI) of the beacon signal, and
the packet further includes the location information of the electronic device.

13. The display apparatus of claim 6, wherein the controller is configured to receive the beacon signal comprising a Bluetooth Low Energy (BLE) signal.

14. A set-top box comprising:
a communicator comprising communication circuitry; and
a controller configured to control the communicator to receive a streaming signal, to transmit a beacon signal including content information acquired by parsing the streaming signal, and to transmit one or more of a video signal and an audio signal based on the streaming signal to a display apparatus.

15. A method of operating an electronic device, the method comprising:
receiving a beacon signal including content information;
acquiring location information based on the beacon signal; and
transmitting a packet to a server, the packet including the content information, the location information, and use log information.

16. The method of claim 15, wherein the location information is acquired based on a received signal strength indication (RSSI) of the beacon signal.

17. The method of claim 15, wherein the beacon signal comprises a Bluetooth Low Energy (BLE) signal.

18. The method of claim 15, wherein the beacon signal is received from one or more of a display apparatus and a set-top box connected to the display apparatus.

19. The method of claim 18, further comprising receiving a second beacon signal from at least one beacon,
wherein the location information is acquired based on the beacon signal and the second beacon signal.

20. A non-transitory computer-readable recording medium having recorded thereon a program which, when executed, causes the electronic device to perform operations recited in claim 15.
